(19) United States
(12) Patent Application Publication
(10) Pub. No.: US 2026/0037435 A1
(43) Pub. Date: Feb. 5, 2026

(54) NVMe SSD AND STORAGE SYSTEM INCLUDING THE SAME

(71) Applicant: EEUM, INC., Campbell, CA (US)

(72) Inventor: Jin Ki HAN, Yangpyeong-gun (KR)

(73) Assignee: EEUM, INC., Campbell, CA (US)

(21) Appl. No.: 19/279,739

(22) Filed: Jul. 24, 2025

(30) Foreign Application Priority Data
Jul. 30, 2024 (KR) 10-2024-0100859

(51) Int. Cl. G06F 12/02; G06F 13/16; G06F 13/42

(52) U.S. Cl. CPC G06F 12/0246; G06F 13/1642; G06F 13/1673; G06F 13/4221

(57) ABSTRACT

Disclosed are a non-volatile memory express solid state drive (NVMe SSD) and a storage system including the same. The NVMe SSD 100 includes a memory controller 110 and performs transmission and reception with an external host 200 through a PCIe bus. The memory controller 110 includes an address translation service (ATS) management unit 111 configured to request an ATS that translates a virtual address into a physical address from the host 200 and address translation buffer memory 112 configured to temporarily store the translated physical address in response to the ATS request received from the host 200.

### CROSS-REFERENCE TO RELATED APPLICATION(S)

This application claims the benefit under 35 USC 119 (a) of Korean Patent Application No. 10-2024-0100859, filed with the Korean Intellectual Property Office on Jul. 30, 2024, the disclosure of which is incorporated herein by reference in its entirety.

### BACKGROUND

### 1. Technical Field

The present disclosure relates to a non-volatile memory express solid state drive (NVMe SSD) and a storage system including the same, and more particularly, to an NVMe SSD capable of efficiently supporting a PCIe address translation service (ATS) and a storage system using the NVMe SSD as a storage device.

### 2. Related Art

The solid state drive (SSD) is a storage device which is used in various computer systems from consumer products to enterprise classes. The SSD basically includes a memory controller and nonvolatile memory, and reads and writes data in response to a request from a host. The SSD may be connected to the host through a serial advanced technology attachment (SATA) bus or a peripheral component interconnect express (PCIe) bus. A PCIe-based SSD is recently in the spotlight because the PCIe bus provides a higher maximum transfer rate and bandwidth scalability than the SATA bus. Accordingly, NVMe specifications were developed in order to fully leverage advantages of the PCIe bus to the maximum extent.

The non-volatile memory express (NVMe) is a protocol based on a submission queue and a completion queue. In general, the submission queue and the completion queue are present in a space of host memory. The host generates a command, stores the command in the submission queue, and indicates that a new command is present in the controller of the NVMe SSD through a submission queue doorbell register update. The submission queue also includes information on a physical region page (PRP), which points to which area data required for a corresponding command is in. The PRP indicates the address of a physical memory page placed in the host memory. The controller of the NVMe SSD fetches a command and information on a PRP from the submission queue, and reads and writes data from a corresponding region of the host memory to direct memory access (DMA) by using the address of a corresponding PRP region. The completed command is added to the completion queue of the host memory. The controller of the NVMe SSD generates an interrupt in order to provide notification that the processing of the command has been completed. The host processes required tasks in accordance with the completion of the command, and writes the results of the tasks in a completion queue doorbell register.

When an input/output (I/O) memory management unit (IOMMU) of the host is enabled, in order for the NVMe SSD to directly access the host memory through DMA, a task that translates an IO virtual address into a physical address is required. The IOMMU of the host performs address translation for each PCIe transaction layer packet (TLP) that is generated in response to a request from the DMA. However, many PCIe TLPs reach PCIe root complex (RC) in response to the DMA request of the NVMe SSD. In this case, a lot of time is taken in a process of the IOMMU performing the address translation on each of TLP. In particular, when a large amount of data is transmitted, further delay inevitably occurs. Furthermore, CPU performance of the host may be limited because overhead occurs.

Accordingly, there is an urgent need for a scheme for solving the conventional host CPU performance restriction problem attributable to the DMA of the NVMe SSD.

### SUMMARY

Various embodiments are directed to providing an NVMe SSD and a storage system including the same, which can directly access host memory based on a physical address by requesting a PCIe address translation service (ATS) from a host and temporarily storing a translated physical address as a response to the request.

In an embodiment, a non-volatile memory express solid state drive (NVMe SSD) includes a memory controller and performs transmission and reception with an external host through a peripheral component interconnect express (PCIe) bus. The memory controller includes an address translation service (ATS) management unit configured to request an ATS that translates a virtual address into a physical address from the host and address translation buffer memory configured to temporarily store the translated physical address in response to the ATS request received from the host.

Furthermore, in the NVMe SSD according to an embodiment of the present disclosure, the memory controller may further include a direct memory access (DMA) engine configured to access host memory of the host based on the physical address that is temporarily stored in the address translation buffer memory.

Furthermore, in the NVMe SSD according to an embodiment of the present disclosure, the memory controller may further include a command processing unit configured to fetch a command and information on a physical region page (PRP) from a submission queue of the host and to execute the fetched command. The address translation buffer memory may store the information on the PRP fetched by the command processing unit.

Furthermore, in the NVMe SSD according to an embodiment of the present disclosure, the ATS management unit may request the ATS for only an address translation target command that permits the ATS by the host, among multiple commands of the host.

Furthermore, in the NVMe SSD according to an embodiment of the present disclosure, the address translation target command may be identified based on a submission queue entry for each command generated by the host.

Furthermore, in the NVMe SSD according to an embodiment of the present disclosure, the virtual address that is the subject of the ATS and a process address space ID (PASID) may be stored in the field of the submission queue entry of the address translation target command. The ATS management unit may request the ATS based on the virtual address and the PASID stored in the field of the submission queue entry.

In an embodiment, a storage system includes a host and a non-volatile memory express solid state drive (NVMe SSD) including a memory controller and performing transmission and reception with the host through a peripheral component interconnect express (PCIe) bus. The memory controller includes an address translation service (ATS) management unit configured to request an ATS that translates a virtual address into a physical address from the host and address translation buffer memory configured to temporarily store the translated physical address in response to the ATS request received from the host.

Furthermore, in the storage system according to an embodiment of the present disclosure, the memory controller may further include a direct memory access (DMA) engine configured to access host memory of the host based on the physical address that is temporarily stored in the address translation buffer memory.

Furthermore, in the storage system according to an embodiment of the present disclosure, the memory controller may further include a command processing unit configured to fetch a command and information on a physical region page (PRP) from a submission queue of the host and to execute the fetched command. The address translation buffer memory may store the information on the PRP fetched by the command processing unit.

Furthermore, in the storage system according to an embodiment of the present disclosure, the host may select an address translation target command that permits the ATS, among multiple commands. The ATS management unit may request the ATS for only the address translation target command.

Furthermore, in the storage system according to an embodiment of the present disclosure, the address translation target command may be identified based on a submission queue entry for each command generated by the host.

Furthermore, in the storage system according to an embodiment of the present disclosure, the host may store the virtual address that is the subject of the ATS and a process address space ID (PASID) in the field of the submission queue entry of the address translation target command. The ATS management unit may request the ATS based on the virtual address and the PASID stored in the field of the submission queue entry.

In an embodiment, an operating method of a memory controller of a non-volatile memory express solid state drive (NVMe SSD) performing transmission and reception with a host through a peripheral component interconnect express (PCIe) bus includes a step (a) of requesting an address translation service (ATS) that translates a virtual address into a physical address from the host, a step (b) of receiving the translated physical address in response to the ATS request from the host, and a step (c) of temporarily storing the received physical address in address translation buffer memory.

Furthermore, the operating method of the memory controller of the NVMe SSD according to an embodiment of the present disclosure may further include accessing host memory of the host based on the physical address that is temporarily stored in the address translation buffer memory.

Furthermore, in the operating method of the memory controller of the NVMe SSD according to an embodiment of the present disclosure, the step (a) may include requesting the ATS for only an address translation target command for which the ATS has been permitted by the host, among multiple commands received from the host.

Furthermore, in the operating method of the memory controller of the NVMe SSD according to an embodiment of the present disclosure, the address translation target command may be identified based on a submission queue entry for each command generated by the host.

Furthermore, in the operating method of the memory controller of the NVMe SSD according to an embodiment of the present disclosure, the virtual address that is the subject of the ATS and a process address space ID (PASID) may be stored in a field of the submission queue entry of the address translation target command. The step (a) may include requesting the ATS based on the virtual address and the PASID stored in the field of the submission queue entry.

Characteristics and advantages of the present disclosure will become more evident from the following detailed description with reference to the accompanying drawings.

Prior to the detailed description, terms or words used in the specification and the claims should not be construed as having common or dictionary meanings, but should be construed as having meanings and concepts that comply with the technical spirit of the present disclosure based on the principle that the inventor may appropriately define the concepts of the terms in order to describe his or her disclosure in the best manner.

According to embodiments of the present disclosure, the host memory is directly accessed without the intervention of the I/O memory management unit (IOMMU) of the host because a virtual address is translated into a physical address by requesting ATS from the host. Accordingly, CPU performance of the host can be maximized because delay that occurs when data are transmitted is prevented and overhead is reduced.

Furthermore, the ATS can be effectively supported because whether to permit the ATS is selected for each NVM command.

### BRIEF DESCRIPTION OF THE DRAWINGS

FIG. 1 is a construction diagram of a storage system according to an embodiment of the present disclosure.

FIG. 2 is a construction diagram of address translation buffer memory illustrated in FIG. 1.

FIG. 3 is a diagram that describes an operation of a command processing unit illustrated in FIG. 1.

FIG. 4 is a construction diagram of a storage system according to another embodiment of the present disclosure.

FIG. 5 is a diagram schematically illustrating a submission queue entry of a storage system according to still another embodiment of the present disclosure.

FIG. 6 is a diagram that describes an ATS request process according to the submission queue entry illustrated in FIG. 5.

FIG. 7 is a flowchart of an operating method of an NVMe SSD according to an embodiment of the present disclosure.

### DETAILED DESCRIPTION

Objects, specific merits and novel characteristics of the present disclosure will become more apparent from the following detailed description and exemplary embodiments taken in conjunction with the accompanying drawings. In adding reference numerals to the components of each drawing in the specification, it should be noted that the same components have the same reference numerals as much as possible even if they are displayed in different drawings. Furthermore, terms, such as a “first” and a “second”, are used to distinguish one component from the other component, and a component is not restricted by the terms. Hereinafter, in describing the present disclosure, the detailed description of a related well-known technology which may obscure the subject matter of the present disclosure will be omitted.

Hereinafter, embodiments of the present disclosure are described in detail with reference to the accompanying drawings.

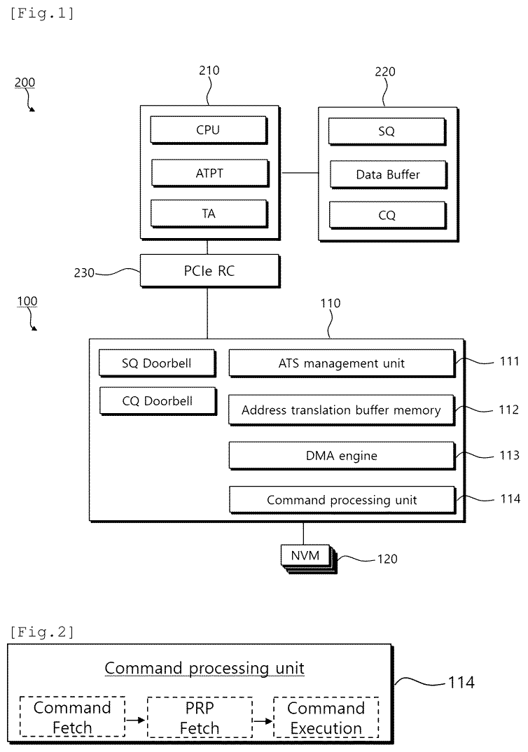

FIG. 1 is a construction diagram of a storage system according to an embodiment of the present disclosure. FIG. 2 is a construction diagram of address translation buffer memory illustrated in FIG. 1. FIG. 3 is a diagram that describes an operation of a command processing unit illustrated in FIG. 1.

As illustrated in FIG. 1, the NVMe SSD 100 according to an embodiment of the present disclosure includes a memory controller 110. In the NVMe SSD 100 that performs transmission and reception with an external host 200 through a PCIe bus, the memory controller 110 includes an ATS management unit 111 that requests an address translation service (ATS) that translates a virtual address into a physical address from the host 200 and address translation buffer memory 112 that temporarily stores a translated physical address in response to an ATS request received from the host 200.

The NVMe SSD 100 according to an embodiment of the present disclosure is a solid state drive (SSD) based on non-volatile memory express (NVMe) protocol. The NVMe SSD 100 is connected to the host 200 through a peripheral component interconnect express (PCIe) bus, and may transmit and receive packets. A packet that is transmitted from the host 200 to the NVMe SSD 100 includes a command and data to be written in the nonvolatile memory 120 of the NVMe SSD 100. A packet that is transmitted from the NVMe SSD 100 to the host 200 includes a response to a command and data read from the nonvolatile memory 120.

The host 200 is an external computing system, and includes a host processor 210, host memory 220, and PCIe root complex (PCIe RC) 230.

The host processor 210 may include one or more central processing units (CPUs) and a translation agent (TA) connected to an address translation and protection table (ATPT).

A process of the host 200 is executed in the CPU. In this case, the host 200 transmits an input-output command, such as read and write commands, to the NVMe SSD 100 based on a virtual address. The read command is a command that instructs specific data to be disposed in the host memory 220 starting from a designated physical address of the host memory 220 by using direct memory access (DMA). Such a command includes a virtual address. Although the input-output command is a write command, the input-output command includes a virtual address that the NVMe SSD 100 needs to translate the virtual address into a physical address on which data to be stored in the NVMe SSD 100 will be fetched by using DMA.

The TA translates a virtual address into a physical address. In this case, the TA determines the address translation based on values stored in the ATPT. Accordingly, data transmission to the host memory 220 or from the host memory 220 may be started by using DMA based on the translated physical address.

The host memory 220 is a region which may be directly accessed by the NVMe SSD 100. The host memory 220 includes a plurality of physical region pages (PRPs). More specifically, the plurality of PRPs may be included in a data buffer within the host memory 220, that is, memory for data storage. In this case, the data buffer is a part of the host memory 220, and is a region which may be independently by the NVMe SSD 100. The PRPs are regions that are logically divided within the host memory 220. When the SSD and the host 200 communicate with each other by using a non-volatile memory express (NVMe) interface, the PRP may be a unit that distinguishes between logical regions in which data will be stored. An NVMe protocol may use a list of PRPs in order to access the host memory 220. The list of PRPs is used to designate a physical memory region that is used for data transmission between the host memory 220 and the nonvolatile memory 120 of the SSD. That is, the PRP indicates the address of a physical page located in the host memory 220 in order for the host 200 to transmit data to the SSD. While an NVMe command is executed, the list of PRPs is used as a list of decryptors indicative of the location and size of a memory buffer. For example, any one of the plurality of PRP may be used for the external host 200 to temporarily store data that are provided to the memory controller 110. Another of the plurality of PRP may be used for the memory controller 110 to temporarily store data that are provided to the host 200. The PRP may be a region that is designated by a PRP entry included in a submission queue (SQ) entry for each command that is provided from the host 200 to the memory controller 110.

The NVMe SQ entry includes fields which may include virtual addresses that are translated before data transmission is performed by using DMA. The fields may include a metadata pointer and pointers for PRP entries PRP1 and PRP2. Furthermore, other fields of the SQ entry may include an OpCode to designate whether a read, write, or other command will be executed, a PRP/SGL flag to designate whether data have an SGL or PRP format, a start LBA to designate a start logic block address for logical blocks to be read or written within the NVMe SSD 100, and the number of LBAs to designate the number of logical blocks to be read or written.

The NVMe SSD 100 according to an embodiment of the present disclosure may include the memory controller 110 and nonvolatile memory (NVM) 120. The memory controller 110 may be a processing circuit or may include the processing circuit. In this case, the processing circuit may refer to an arbitrary combination of hardware, firmware, and software which are used to process data or digital signals. The processing circuit hardware may include programmable logic devices, such as application-specific integrated circuits (ASICs), general or special-purpose central processing units (CPUs), digital signal processors (DSPs), graphic processing units (GPUs), and the field programmable gate arrays (FPGAs), for example. In the processing circuit that is used in this specification, each function may be performed by hardware (i.e., hardwired) configured to perform a corresponding function or may be performed by more general-purpose hardware configured to execute commands stored in a non-transitory storage medium, such as a CPU. The processing circuit may be manufactured in a single printed circuit board (PCB) or may be distributed to several PCBs that are mutually connected. The processing circuit may include other processing circuits. For example, the processing circuit may include an FPGA and a CPU, that is, two processing circuits that are connected to a PCB.

The memory controller 110 may control the nonvolatile memory 120 to perform a program operation, a read operation, or an erase operation in response to a request from the host 200. In this case, the nonvolatile memory 120 may be NAND flash memory.

The memory controller 110 of the NVMe SSD 100 according to an embodiment of the present disclosure includes the ATS management unit 111 and the address translation buffer memory 112.

The ATS management unit 111 requests an address translation service (ATS) that translates a virtual address into a physical address in order to process a command of the host 200 from the host 200. The ATS request may be a request for requesting the reading of data stored in the host memory 220 or the writing of data in the host memory 220 in order to process a command of the host 200. The host 200 transmits an ATS response to the ATS request to the memory controller 110. In this case, the TA of the host processor 210 may translate a virtual address, that is, the subject of the ATS request, into a physical address. The translated physical address may be received by the ATS management unit 111.

The address translation buffer memory 112 temporarily stores a translated physical address as an ATS response. The temporarily stored physical address is used to perform a DMA operation. After the DMA operation is completed, a corresponding physical address related to DMA may be deleted from the address translation buffer memory 112.

The memory controller 110 of the NVMe SSD 100 according to an embodiment of the present disclosure may further include a DMA engine 113 that performs a DMA operation. The DMA engine 113 may access the host memory 220 based on a physical address that is temporarily stored in the address translation buffer memory 112.

Furthermore, the memory controller 110 may include a command processing unit 114. Referring to FIG. 2, the command processing unit 114 executes a command by fetching the command and information on a PRP from the submission queue (SQ) of the host 200.

NVMe is a protocol based on a submission queue (SQ) and a completion queue (CQ). The submission queue and the completion queue are present in the space of the host memory 220. The host processor 210 stores a command and information on a PRP in the submission queue, and indicates a corresponding command in the memory controller 110 through a submission queue doorbell register update. In this case, the ATS management unit 111 receives the physical address of the submission queue through an ATS request. The received physical address of the submission queue is temporarily stored in the address translation buffer memory 112. The DMA engine 113 may directly access the submission queue of the host memory 220 even without the address translation of the I/O memory management unit (IOMMU) of the host 200 based on the temporarily stored physical address of the submission queue. Accordingly, the command processing unit 114 may fetch the command from the submission queue.

When information on a PRP is fetched, the ATS management unit 111 receives the physical address of data, that is, the subject of DMA, in advance through an ATS request. The received physical address of the data is temporarily stored in the address translation buffer memory 112. The DMA engine 113 may access the data buffer of the host memory 220 based on the stored physical address. Even in this case, the DMA engine 113 may directly access the data buffer of the host memory 220 even without the address translation of the IOMMU.

When the execution of a command by the command processing unit 114 is completed, the ATS management unit 111 receives the physical address of a completion queue through an ATS request to the completion queue. Even in this case, the received physical address of the completion queue is temporarily stored in the address translation buffer memory 112. The DMA engine 113 may directly access the completion queue of the host memory 220 based on the stored physical address of the completion queue.

When the processing of a corresponding command is completed, the command processing unit 114 may transmit an interrupt to the host 200 in order to provide notification that the processing of the command has been completed.

Referring to FIG. 3, the address translation buffer memory 112 receives the physical address of a submission queue, the physical address of data, and the physical address of a completion queue in response to an ATS request from the ATS management unit 111. The address translation buffer memory 112 may include an SQ address translation buffer (SQ ATB) that temporarily stores the physical address of a submission queue, a data DMA address translation buffer (DATA DMA ATB) that temporarily stores the physical address of data, and a CQ address translation buffer (CQ ATB) that temporarily stores the physical address of a completion queue. In this case, the address translation buffer memory 112 does not need to essentially include the SQ address translation buffer (SQ ATB), the data DMA address translation buffer (DATA DMA ATB), and the CQ address translation buffer (CQ ATB), and may include a piece of integrated single buffer memory or include only one or more buffers.

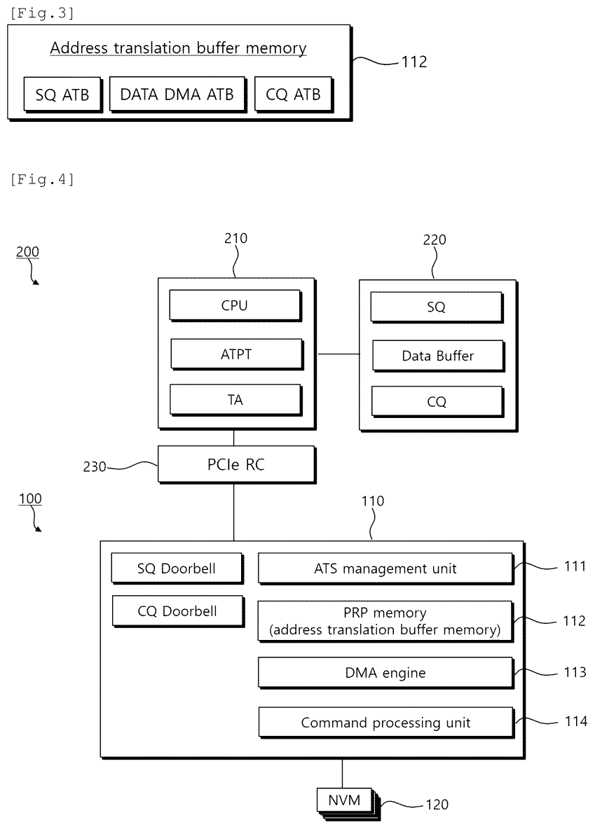

FIG. 4 is a construction diagram of a storage system according to another embodiment of the present disclosure.

As illustrated in FIG. 4, in the storage system according to another embodiment of the present disclosure, an address translation buffer memory 112 of a memory controller 110 may store information on a PRP that is fetched by a command processing unit 114.

Referring to FIGS. 1 and 3, the NVMe SSD 100 that constitutes the storage system according to an embodiment of the present disclosure implements the address translation buffer memory 112 as separate buffer memory. In contrast, an NVMe SSD 100 that constitutes the storage system according to another embodiment of the present disclosure uses PRP memory of a common NVMe SSD as the address translation buffer memory 112.

Conventionally, an NVMe SSD may store information on a PRP in the entry field of a submission queue, for example, PRP entries PRP1 and PRP2. In this case, the PRP1 entry may designate the address of a physical page placed in the host memory 220. The PRP2 entry may designate a list of PRPs. Information on the PRP that is fetched from a submission queue is stored in PRP memory. The memory controller 110 of the NVMe SSD 100 according to another embodiment of the present disclosure may temporarily store a physical address received as a response to the ATS request of the ATS management unit 111 by using conventional PRP memory as the address translation buffer memory 112 without adding separate buffer memory. In this case, information on a PRP and a translated physical address area stored in the PRP memory.

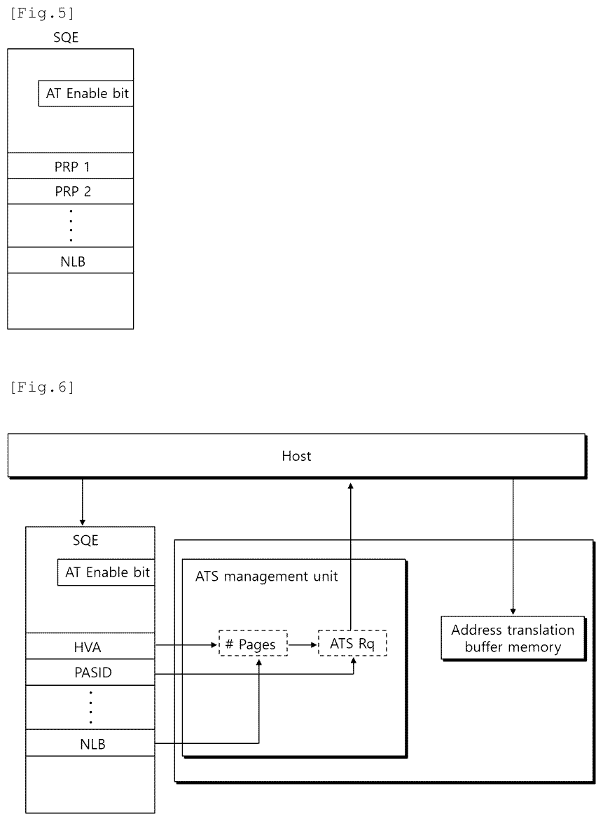

FIG. 5 is a diagram schematically illustrating a submission queue entry of a storage system according to still another embodiment of the present disclosure. FIG. 6 is a diagram that describes an ATS request process according to the submission queue entry illustrated in FIG. 5.

A storage system according to still another embodiment of the present disclosure partially modifies the existing NVMe protocol in order to effectively support an ATS.

The storage system according to the embodiment may support the PCIe ATS in the state in which the existing NVMe protocol has been maintained. In this case, although data access patterns, such as a submission queue, a completion queue, and data transmission, are different, the storage system requests address translation in a lump. If address translation is performed on different data access patterns in a lump as described above, there may be a problem in that the address translation is unnecessarily performed.

The storage system according to still another embodiment of the present disclosure may select whether to permit address translation for each command and permit the address translation for only a selected command. In this case, the storage system may access the host memory 220 through the IOMMU of the host 200 with respect to a command for which address translation is not permitted.

Specifically, the host 200 may select a command that permits an ATS, among multiple commands for the NVMe SSD 100. Hereinafter, a command that permits an ATS is called an “address translation target command”. Whether a command is an address translation target command may be identified based on a submission queue entry for each command that is generated by the host 200.

Referring to FIGS. 5 and 6, an AT Enable bit that permits address translation may be included in a submission queue entry SQE for each command. When the AT Enable bit is “1”, an ATS is permitted for a corresponding command. When the AT Enable bit is “0”, an ATS is not permitted for a corresponding command. As a result, the host processor 210 may determine whether to permit an ATS for each command. The ATS management unit 111 may selectively request an ATS from the host processor 210 with respect to only an address translation target command that permits the ATS.

For example, when a PRP is fetched, if the host processor 210 does not permit an ATS for data transmission, the host memory 220 may be accessed through the IOMMU of the host processor 210 by using the PRP1 entry and PRP2 entry of the submission queue entry SQE for a corresponding command as in a conventional NVMe SSD (refer to FIG. 5).

As another example, the host processor 210 may selectively permit an ATS for only data transmission, among a submission queue, a completion queue, and the data transmission having different data access patterns. In this case, a virtual address, that is, the subject of the ATS, may be stored in one of the PRP1 entry and the PRP2 entry that are not used in the field of the submission queue entry SQE of a corresponding command, and a process address space ID (PASID) may be stored in the other of the PRP1 entry and the PRP2 entry. However, the virtual address, that is, the subject of an ATS, and the process address space ID (PASID) should not be essentially stored in the PRP1 entry and the PRP2 entry, and may be stored in another reserved field of the submission queue entry SQE. Accordingly, the ATS management unit 111 may request an ATS from the host 200 depending on the type of submission queue entry SQE for each command. A physical address received as a response to an ATS request may be temporarily stored in the address translation buffer memory 112.

Hereinafter, an operating method of the memory controller of the NVMe SSD supporting an ATS according to an embodiment of the present disclosure is described.

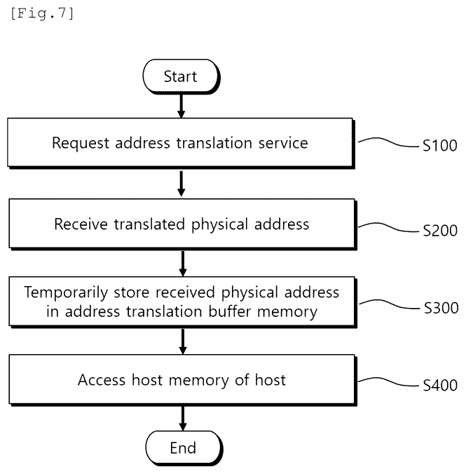

FIG. 7 is a flowchart of an operating method of an NVMe SSD according to an embodiment of the present disclosure.

As illustrated in FIG. 7, the operating method of the memory controller of the NVMe SSD according to an embodiment of the present disclosure is an operating method of the memory controller of the NVMe SSD that performs transmission and reception with the host through the PCIe bus, and includes step S100 of requesting an address translation service (ATS) that translates a virtual address into a physical address from the host, step S200 of receiving the translated physical address in response to the ATS request from the host, and step S300 of temporarily storing the received physical address in the address translation buffer memory.

The operating method of the memory controller of the NVMe SSD according to an embodiment of the present disclosure relates to a method of supporting an ATS by the memory controller of the NVMe SSD that performs transmission and reception with a host. The NVMe SSD and the host according to an embodiment of disclosure have been described, and redundant contents are not described or described in brief.

In this case, the host is an external computing system, and includes a host processor, host memory, and PCIe root complex (RC). The NVMe SSD includes a memory controller implemented by a processing circuit and nonvolatile memory. In this case, the host and the NVMe SSD transmit and receive packets to and from each other through the PCIe bus.

The memory controller may include an ATS management unit and address buffer memory. In this case, the address buffer memory may be implemented as separate memory or may be implemented as PRP memory of the existing NVMe SSD. Furthermore, the memory controller may further include a DMA engine. Furthermore, the memory controller may further include a command processing unit.

Specifically, the operating method of the memory controller includes the ATS request step S100, the physical address reception step S200, and the physical address-temporary storage step S300.

In the ATS request step S100, in order to process a command of the host, the memory controller requests an ATS that translates a virtual address into a physical address from the host. The host transmits an ATS response (i.e., the translated physical address) to the ATS request to the memory controller. In this case, the host processor (e.g., the TA) may translate the virtual address, that is, the subject of the ATS request, into the physical address. The ATS request may be performed by the ATS management unit.

In the physical address reception step S200, the memory controller receives the translated physical address in response to the ATS request. In this case, the physical address may be received through the ATS management unit.

In the physical address-temporary storage step S300, the memory controller may temporarily store the received physical address in the address buffer memory. The temporarily stored physical address is used to perform a DMA operation. After the DMA operation is completed, a corresponding physical address related to the DMA may be deleted from the address translation buffer memory.

The operating method of the memory controller may further include the host memory access step S400. In this case, the memory controller may directly access the host memory by using the physical address temporarily stored in the address translation buffer memory. The DMA operation may be performed for the DMA engine of the memory controller.

When the virtual address is translated in the physical address in response to the ATS request, the memory controller may directly access the host memory without the intervention of the IOMMU of the host, may fetch a command and information on a PRP from the submission queue (SQ) of the host, and may execute the command. Such an operation may be performed by the command processing unit.

NVMe is a protocol based on a submission queue (SQ) and a completion queue (CQ). The memory controller may receive the physical address of the submission queue in response to an ATS request, may temporarily store the received physical address of the submission queue in the address translation buffer memory, and may directly access the submission queue of the host memory even without the address translation of the I/O memory management unit (IOMMU) of the host based on the temporarily stored physical address of the submission queue.

When information on an PRP is fetched, the data buffer of the host memory can be accessed even without the address translation of the IOMMU based on the physical address of data by receiving the physical address, that is, the subject of DMA, in advance in response to an ATS request, and temporarily storing the physical address of the data in the address translation buffer memory.

When the execution of the command is completed, a physical address for a completion queue may be received in response to an ATS request for the completion queue. After the physical address of the completion queue is temporarily stored in the address translation buffer memory, the completion queue of the host memory may be directly accessed based on the stored physical address of the completion queue.

When the processing of a corresponding command is completed, an interrupt may be transmitted in order to notify the host that the processing of the command has been completed.

In a method of supporting an ATS by the memory controller of the NVMe SSD according to another embodiment of the present disclosure, in order to effectively support an ATS, a protocol that is partially modified from the existing NVMe protocol may be used.

The partially modified NVMe protocol is operated to select whether to permit address translation for each command and to permit the address translation for only a selected command. In this case, the host memory may be accessed through the IOMMU of the host with respect to a command that does not permit the address translation.

The host may select an address translation target command that permits an ATS, among multiple commands for the NVMe SSD. Whether a command is an address translation target command may be identified based on a submission queue entry for each command generated by the host.

The AT Enable bit that permits address translation is included in the submission queue entry SQE for each command. When the AT Enable bit is “1”, an ATS is permitted for a corresponding command. When the AT Enable bit is “0”, an ATS is not permitted for a corresponding command. As a result, the host processor determines whether to permit the ATS for each command. The ATS management unit may selectively request an ATS from the host processor with respect to only an address translation target command that permits the ATS.

When a PRP is fetched, if the host processor does not permit an ATS for data transmission, the host memory is accessed through the IOMMU of the host processor by using the PRP1 entry and PRP2 entry of the submission queue entry SQE for a corresponding command.

The host processor may selectively permit an ATS with respect to only one of a submission queue, a completion queue, and data transmission having different data access patterns. A case in which an ATS is permitted for the data transmission is taken as an example. A virtual address, that is, the subject of an ATS, and a process address space ID (PASID) may be stored in the PRP1 entry and the PRP2 entry that are not used in the field of the submission queue entry SQE of a corresponding command. However, the virtual address, that is, the subject of the ATS, and the process address space ID (PASID) should not be essentially stored in the PRP1 entry and the PRP2 entry, and may be stored in the reserved field of another submission queue entry SQE. Accordingly, the memory controller may request an ATS from the host depending on the type of submission queue entry SQE for each command.

In other words, according to embodiments of the present disclosure, the host memory can be directly accessed without the intervention of the I/O memory management unit (IOMMU) of the host by translating a logical address into a physical address by requesting an ATS from the host. Accordingly, CPU performance of the host can be maximized by preventing delay that occurs when data are transmitted and reducing overhead. Furthermore, an ATS can be effectively supported by selecting whether to permit the ATS for each NVM command.

The detailed embodiments of the present disclosure have been described above, but merely illustrate embodiments of the present disclosure. It is evident that the present disclosure is not limited to the detailed embodiments and may be modified or improved by a person having ordinary knowledge in the art within the technical spirit of the present disclosure.

A simple modification or change of the present disclosure belongs to the scope of the present disclosure, and a detailed scope of protection of the present disclosure will become evident by the claims.

[Description of reference numerals]

| | |
|---|---|
| 100: NVMe SSD | 110: memory controller |
| 111: ATS management unit | |
| 112: address translation buffer memory | |
| 113: DMA engine | 114: command processing unit |
| 120: nonvolatile memory | 200: host |
| 210: host processor | 220: host memory |
| 230: PCIe root complex | |

What is claimed is:

1. A non-volatile memory express solid state drive (NVMe SSD) comprising a memory controller and performing transmission and reception with an external host through a peripheral component interconnect express (PCIe) bus, wherein the memory controller comprises:
an address translation service (ATS) management unit configured to request an ATS that translates a virtual address into a physical address from the host; and
address translation buffer memory configured to temporarily store the translated physical address in response to the ATS request received from the host.

2. The NVMe SSD of claim 1, wherein the memory controller further comprises a direct memory access (DMA) engine configured to access host memory of the host based on the physical address that is temporarily stored in the address translation buffer memory.

3. The NVMe SSD of claim 1, wherein:
the memory controller further comprises a command processing unit configured to fetch a command and information on a physical region page (PRP) from a submission queue of the host and to execute the fetched command, and
the address translation buffer memory stores the information on the PRP fetched by the command processing unit.

4. The NVMe SSD of claim 1, wherein the ATS management unit requests the ATS for only an address translation target command that permits the ATS by the host, among multiple commands of the host.

5. The NVMe SSD of claim 4, wherein the address translation target command is identified based on a submission queue entry for each command generated by the host.

6. The NVMe SSD of claim 5, wherein:
the virtual address that is a subject of the ATS and a process address space ID (PASID) are stored in a field of the submission queue entry of the address translation target command, and
the ATS management unit requests the ATS based on the virtual address and the PASID stored in the field of the submission queue entry.

7. A storage system comprising:
a host; and
a non-volatile memory express solid state drive (NVMe SSD) comprising a memory controller and performing transmission and reception with the host through a peripheral component interconnect express (PCIe) bus,
wherein the memory controller comprises:
an address translation service (ATS) management unit configured to request an ATS that translates a virtual address into a physical address from the host; and
address translation buffer memory configured to temporarily store the translated physical address in response to the ATS request received from the host.

8. The storage system of claim 7, wherein the memory controller further comprises a direct memory access (DMA) engine configured to access host memory of the host based on the physical address that is temporarily stored in the address translation buffer memory.

9. The NVMe SSD of claim 1, wherein:
the memory controller further comprises a command processing unit configured to fetch a command and information on a physical region page (PRP) from a submission queue of the host and to execute the fetched command, and
the address translation buffer memory stores the information on the PRP fetched by the command processing unit.

10. The storage system of claim 7, wherein:
the host selects an address translation target command that permits the ATS, among multiple commands, and
the ATS management unit requests the ATS for only the address translation target command.

11. The storage system of claim 10, wherein the address translation target command is identified based on a submission queue entry for each command generated by the host.

12. The storage system of claim 11, wherein:
the host stores the virtual address that is a subject of the ATS and a process address space ID (PASID) in a field of the submission queue entry of the address translation target command, and
the ATS management unit requests the ATS based on the virtual address and the PASID stored in the field of the submission queue entry.

13. An operating method of a memory controller of a non-volatile memory express solid state drive (NVMe SSD) performing transmission and reception with a host through a peripheral component interconnect express (PCIe) bus, the operating method comprising:
a step (a) of requesting an address translation service (ATS) that translates a virtual address into a physical address from the host;
a step (b) of receiving the translated physical address in response to the ATS request from the host; and
a step (c) of temporarily storing the received physical address in address translation buffer memory.

14. The operating method of claim 13, further comprising accessing host memory of the host based on the physical address that is temporarily stored in the address translation buffer memory.

15. The operating method of claim 13, wherein the step (a) comprises requesting the ATS for only an address translation target command for which the ATS has been permitted by the host, among multiple commands received from the host.

16. The operating method of claim 15, wherein the address translation target command is identified based on a submission queue entry for each command generated by the host.

17. The operating method of claim 16, wherein:
the virtual address that is a subject of the ATS and a process address space ID (PASID) are stored in a field of the submission queue entry of the address translation target command, and
the step (a) comprises requesting the ATS based on the virtual address and the PASID stored in the field of the submission queue entry.
